(19) United States
(12) Patent Application Publication
(10) Pub. No.: US 2004/0146833 A1
(43) Pub. Date: Jul. 29, 2004

(54) Construction of a dental prosthesis using bilaminar fiber reinforcement

(76) Inventor: Scott R. Dyer, Wilsonville, OR (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/703,106

(22) Filed: Nov. 6, 2003

Related U.S. Application Data
(60) Provisional application No. 60/424,253, filed on Nov. 6, 2002.

(51) Int. Cl. A61C 13/00

(52) U.S. Cl. 433/167; 433/199.1

(57) ABSTRACT

A portion of a dental prosthesis may include at least two support layers formed within a pliable material. At least two of the support layers may be positioned within the pliable material in a substantially parallel orientation to one another. A first support layer may be positioned within a predetermined range of a first surface of a dental prosthesis. A second support layer may be positioned within a predetermined range of a second surface of a dental prosthesis. A support layer may allow a portion of a dental prosthesis to include a thickness within a predetermined range. A method of forming a portion of a dental prosthesis is also disclosed.

### PRIORITY CLAIM

This application claims priority to U.S. Provisional Patent Application Serial No. 60/424,253 filed on Nov. 6, 2002, entitled “CONSTRUCTION OF A DENTAL PROSTHESIS USING BILAMINAR FIBER REINFORCEMENT”, the disclosures of which are hereby incorporated by reference.

### BACKGROUND

1. Field of the Invention

The present invention generally relates to a method of reinforcing dental prostheses. Embodiments of the invention relate to a method of forming a reinforced dental prosthesis with improved properties.

2. Description of Related Art

Polymer devices and constructions in dentistry have traditionally been reinforced with metal inclusions in the polymer. The effect of the metal inclusions in the strength of the polymer device or construction is, however, inadequate. Attempts have been made to develop a polymer-fiber composite that can easily be used as reinforcement of dental prostheses. Fiber-reinforced composites have found increasing use in the field of materials for dental restorations, and are described, for example, in U.S. Pat. Nos. 4,717,341 and 4,894,012 to Goldberg et al., as well as U.S. Pat. No. 4,107,845 to Lee, Jr. et al. Fiber-reinforced composites generally comprise at least two components, a polymeric matrix and fibers embedded within the matrix. The composite materials may further comprise other filler materials and/or act as a filler component within a construction. Common polymeric matrices include those known for use in composite dental materials, for example polyamides, polyesters, acrylates, polyolefins, polyimides, polyacrylates, polyurethanes, vinyl esters, or epoxy-based materials. Other polymeric matrices include styrenes, styrene acrylonitriles, ABS polymers, polysulfones, polyacetals, polycarbonates, polyphenylene sulfides, and the like. The fibers used to reinforce composite material may comprise glass, carbon, or polymer fibers such as polyaramide and polyethylene, as well as other natural and synthetic fibers.

Fiber-reinforced composite materials provide several advantages, most notably increased strength and stiffness. As described in U.S. Pat. Nos. 4,717,341 and 4,894,012 to Goldberg et al., the contents of which are incorporated by reference herein, such materials may be used as structural components in a variety of dental appliances, taking the form of bars, wires, beams, posts, clasps, and laminates. The fibers preferably take the form of long, continuous filaments, although the filaments may be as short as 3 to 4 millimeters. Where the composites take the form of elongated bars, the fibers are at least partially aligned and oriented along the longitudinal dimensions of the bar. However, depending on the end use of the composite material, the fibers may also be otherwise oriented, including being normal or perpendicular to that dimension. These structural components are used in traditional bridges, crowns, artificial teeth, dentures, implants, veneers as well as in connection with orthodontic retainers, space maintainers, splints, etc.

Currently fiber-reinforcement materials are used to increase the mechanical properties of industrial and dental polymers. Fiber-reinforced composite materials are currently used to provide stiffer and stronger constructions than polymer materials alone. However, little study has been performed to determine how to best design and form these fiber-reinforced composite materials to take full advantage of their properties in conjunction with dental prosthesis.

### SUMMARY

A portion of a dental prosthesis may include at least two support layers formed within a pliable material. At least two of the support layers may be positioned within the pliable material. In an embodiment, at least two of the support layers may be in a substantially parallel orientation to one another. A first support layer may be positioned within a predetermined range of a first surface of a dental prosthesis. A first support layer may be within about 100 microns of a first surface of a dental prosthesis. A second support layer may be positioned within a predetermined range of a second surface of a dental prosthesis. A second support layer may be positioned within about 100 microns of a second surface of a dental prosthesis. A support layer may allow a portion of a dental prosthesis to include a thickness within a predetermined range (e.g., less than about 1 mm).

A particular method of forming a portion of a dental prosthesis may include luting a tooth set up and rim to a cast with wax. A wax contour may be added to a palate and flask. A support layer may be sized to the palate. A support layer may be prepared with pre-polymer and/or monomer. A thin layer of resin may be positioned on a support layer. An amount of resin may be placed between a cast and a support layer in a cope and drag. Resin may be placed into the mold for a trial pack with a separating sheet. Support layer position may be verified upon opening the trial pack. Excess resin may be trimmed from a dental prosthesis.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a load to initial fracture of various cross-sectional designs of fiber-reinforced materials.

FIG. 2 depicts an embodiment of a cross-section of a dental prosthesis.

FIG. 3 depicts an embodiment of a cast of an impression of a portion of an edentulous maxilla.

FIG. 4 depicts an embodiment of a cast coupled to a palate and a flask.

FIG. 5 depicts an embodiment of a fiber sheet during preparation.

FIG. 6 depicts an embodiment of a cast combined with a fiber sheet during preparation.

FIG. 7 depicts an embodiment of a trial pack during preparation.

FIG. 8 depicts an embodiment of a portion of a trial pack.

FIG. 9 depicts an embodiment of an intaglio face of a dental prosthesis.

FIG. 10 depicts an embodiment of a representation of light transmission through a portion of a cameo face of a dental prosthesis.

FIG. 11 depicts an embodiment of an impression and a mandibular pediatric complete denture formed using method described herein.

FIG. 12 depicts an embodiment of an impression and a maxillary pediatric removable partial denture formed using method described herein.

FIGS. 13A-D depict embodiments of cross-sectional designs within the bilaminar fiber-reinforcement.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF EMBODIMENTS

In the context of the invention, dental prostheses are to be understood as meaning all possible forms of dentures, such as prostheses or prosthetic elements such as dentures in partially dentate or edentulous jaws, as well as artificial teeth, crowns and bridge elements. Fixed prostheses or prosthetic elements are understood as meaning technical dental aids which include at least one artificial tooth coupled to another tooth and/or support elements (including the necessary supporting or otherwise functional elements), such elements maintaining their mutual position and distance after removal from the jaw position.

The prostheses or prosthetic elements may—after prior adaptation by appropriately trained technical personnel (e.g., a dentist, etc.)—either be inserted into the mouth or removed therefrom by the prosthesis wearer in a simple manner or be fastened indirectly or directly to the jaw in such a way that they may only be inserted or removed by technical personnel. The prosthesis may rest on the oral mucous membrane, on residual teeth and/or on dental elements (e.g., dental implants). For fastening or stabilization of the prosthesis, various dental measures or elements may be provided.

A prosthetic part generally includes artificial teeth which are coupled to a support base directly resting on the jaw covered with a mucous membrane or which are mounted on the support base. The artificial teeth are usually tooth-colored and, like the support base, which is generally composed of gum-colored plastic, have a functional and an aesthetic or cosmetic function. For reinforcement, reduction of fractures, stabilization or holding of dental elements or for corresponding reasons, an additional reinforcement may be necessary for the dental prosthesis. The reinforcing framework serving as a support part may be present in prefabricated form, or prepared specially for an individual prosthesis, and this framework may be incorporated into the dental prosthesis by polymerization during the production of the dental prosthesis. However, in specific cases, the framework may also be incorporated subsequently into a hardened prosthetic part.

Support layers may be used to affect the physical properties of pliable materials. Physical properties affected may include, but are not limited to, strength, durability, elastic modulus, toughness, elasticity, heat transference, etc. Pliable materials may include polymers (e.g., polymethylmethacrylate (PMMA)). Increasing such properties as strength and durability of pliable materials in dental prostheses may allow portions of the dental prosthesis to be formed thinner than current methods allow. For example, a thinner palate of a denture may increase patient comfort, sensitivity to heat, etc.

Support layers may include fiber sheets. A fiber sheet may be woven. A fiber sheet may include an e-glass fiber matte (e.g., Stick Net, Stick Tech, Turku, Finland). Fiber sheets may include other woven, pliable sheets. A number of support layers included in a pliable material may vary the effect of the support layers on the pliable material. A spatial relationship of support layers to one another may vary the affect of the support layers on a pliable material. A spatial relationship of support layers to the surface of a pliable material may vary an affect of the support layers on the pliable material. A distance of a support layer from the surface of a pliable material may vary an effect of the support layers on the pliable material.

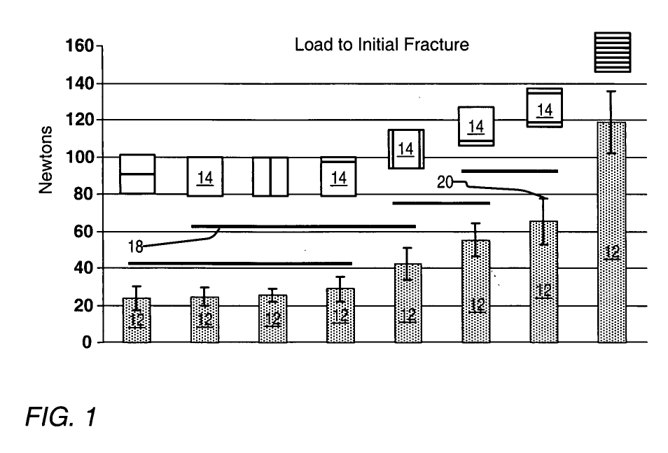

FIG. 1 depicts a load/force to initial fracture of various cross-sectional designs of support layer reinforced materials. 2 mm×2 mm×25 mm samples were prepared with different cross-sectional designs of support layer reinforcement. The squares 14 above shaded bars 12 are pictorial representations of a cross-sectional design of a support layer reinforcement. Shaded bars 12 represent the amount of force and/or load placed upon a pliable material before the pliable material failed (i.e., initial fracture). Horizontal bars 18 depict overlap between different cross-section designs which are not significantly different in an amount of force required to fracture a cross-sectional design. Y-bars 20 represent the standard deviation of the force applied to the different cross-sectional designs before initial fracture. FIG. 1 provides evidence that a number of factors affect how support layers may affect a number of physical properties of a pliable material (e.g., number of support layers, spatial relationship of support layers to the surface of the pliable material, and/or distance from the support layer to the surface of the pliable material).

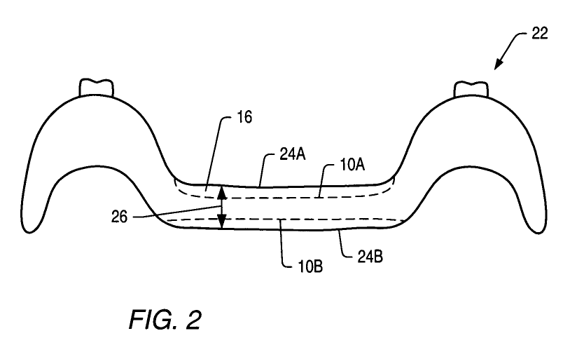

FIG. 2 depicts an embodiment of a cross-section of dental prosthesis 22. Dental prosthesis 22 may include pliable material 16, first support layer 10A, and second support layer 10B. First support layer 10A may be positioned adjacent first surface 24A of pliable material 16. First surface 24A may include the cameo surface of dental prosthesis 22. Support layer 10A may be between about 10 microns to about 100 microns from first surface 24A of dental prosthesis 22. In an embodiment, support layer 10A may be about 50 microns from second surface 24A of dental prosthesis 22. Second support layer 10B may be positioned adjacent second surface 24B of dental prosthesis 22. Second surface 24B may include the intaglio surface of dental prosthesis 22. Support layer 10B may be between about 10 microns to about 100 microns from second surface 24B of dental prosthesis 22. In an embodiment, support layer 10B may be about 50 microns from second surface 24B of dental prosthesis 22. Due at least in part to the increased structural stability afforded dental prosthesis 22 by support layers 10(A-B), thickness 26 of a portion of dental prosthesis 22 may be less than a dental prosthesis formed from a pliable material using current methods. Thickness 26 may be less than about 1 mm. In an embodiment, thickness 26 may be between about 0.4 mm and about 0.75 mm. Decreasing thickness 26 may increase temperature/heat transfer and/or patient comfort.

Although advantages of using the methods and systems described herein have been discussed as far as the ability to form much thinner dental prostheses than current methods, this should not be seen as limiting. Though it is a great selling point to have the prosthesis be in a thin application, in some embodiments the method and/or system may be beneficial to extend the idea from 0-3 mm, the normal thickness range of denture prostheses. In certain embodiments, the method and/or system may be beneficial to construct denture prostheses up to 10 mm in thickness.

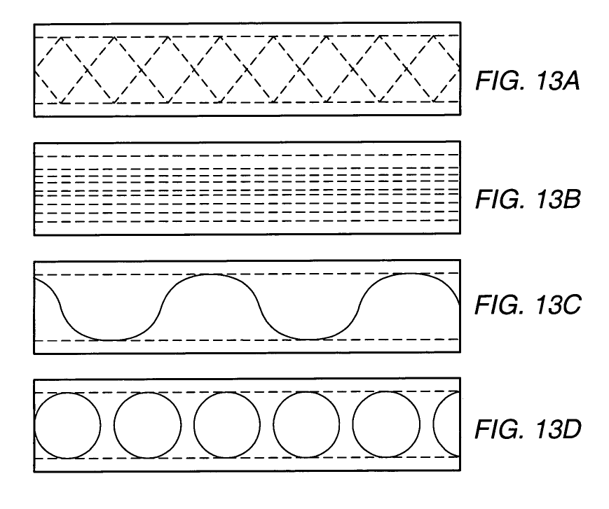

In some embodiments, different materials and/or material configurations may be included between support layers. In an embodiment, one or more additional support layers may be positioned between the original support layers. In certain embodiments, laminate composites of unidirectional, multidirectional, and/or random fibers may be developed and used. In some embodiments, designs such as cellular solids (like a honeycomb), wave patterns, and the like may be used. Examples of these designs are depicted in FIGS. 13A-D.

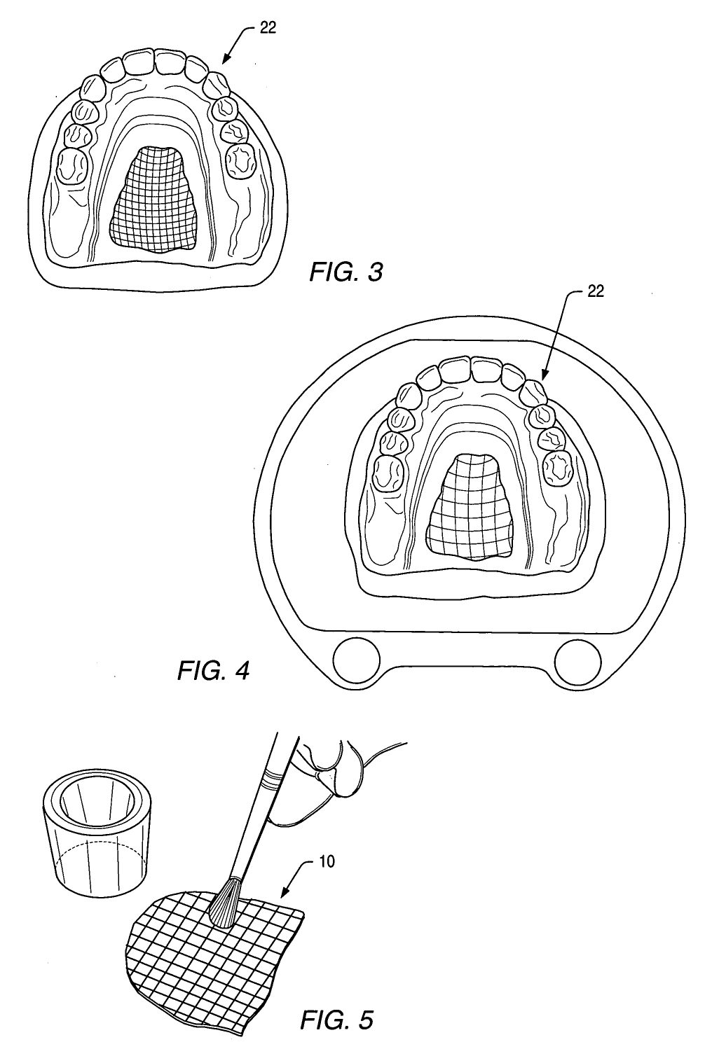

FIGS. 3-10 depict a method for forming dental prosthesis 22 from pliable material 16 including support layers 10. Dental prosthesis 22 may include a denture as depicted in FIGS. 3-4 and 6-9. Impressions may be formed of a portion of a patient's edentulous maxilla. Casts, record bases, and/or occlusal rims may be fabricated after conventional prosthodontic technique. Occlusal vertical dimension, tooth set up, and post dam placement may be established. A palate may be removed from an accepted tooth set up according to Mattie and Phoenix (J. Prosthet. Dent., 2000. 76 (5): p496-9, incorporated by reference, as if set forth herein).

As depicted in FIG. 3, a tooth set up and rim may be luted to the cast with base plate wax. The wax contour may be added to a palate and flask, as depicted in FIG. 4. The palate may be between about 0.5 mm and about 1.0 mm. A wax contour depicted in FIG. 4 may be boiled out and prepared for processing as known to one skilled in the art.

In some embodiments, as depicted in FIG. 5, support layers 10 may be sized to a palate. Support layers 10 may be wetted with a pre-polymer/monomer (e.g., PMMA powder and methylmethacrylate (MMA) monomer) for about 10 minutes. A thin layer of a resin (about 50 microns to about 150 microns) may be applied to support layers 10.

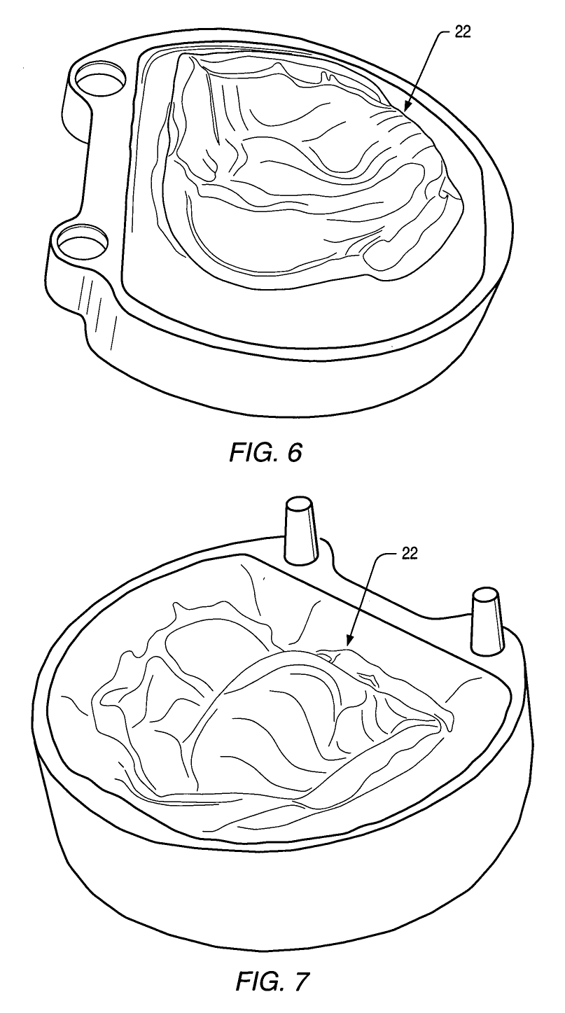

In an embodiment, a pre-polymer/monomer (e.g., PMMA powder and MMA monomer) may be combined as per manufacturer's recommendation. The combination may be allowed to set until a doughy resin is formed. The resin may be placed between the cast and support layers in the cope and drag (as depicted in FIG. 6). This may place resin at dental prosthesis surface 22. Placing resin between the cast and support layers in the cope and drag may keep support layers in a correct position.

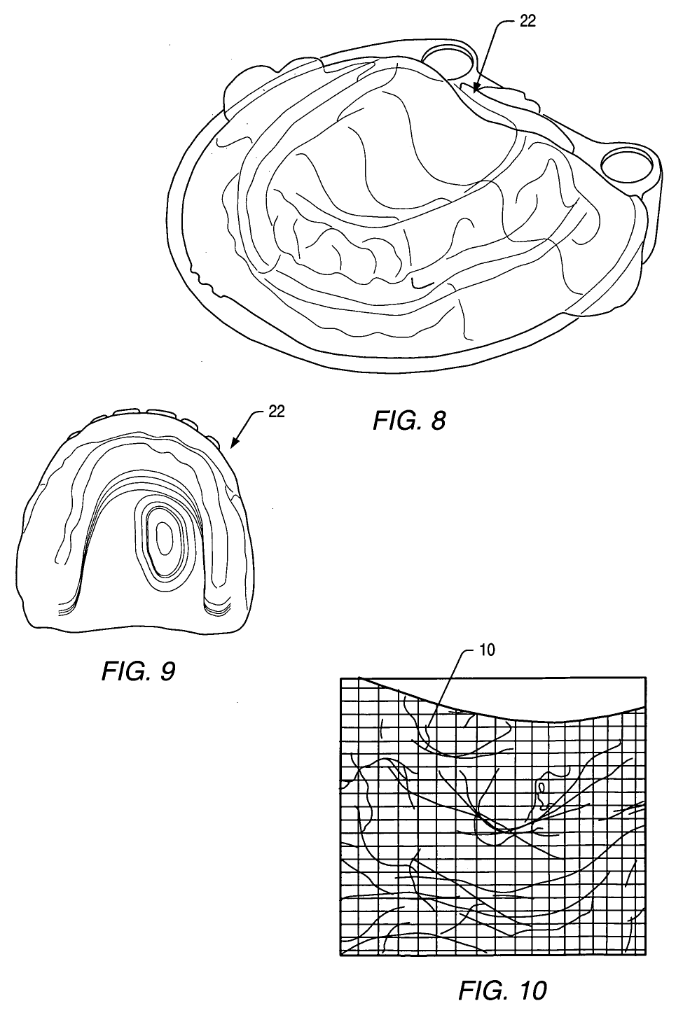

In an embodiment, a resin (e.g., denture resin) may be placed into a mold for a trial pack with a separating sheet (e.g., cellophane). The position of support layers may be verified upon opening the trial pack (as depicted in FIGS. 7 and 8).

In some embodiments, excess resin may be trimmed upon removal of dental prosthesis 22 from a trial pack (as depicted in FIG. 9). Dental prosthesis 22 may be processed and finished according to conventional laboratory protocol. FIG. 9 depicts an embodiment of an intaglio face of dental prosthesis 22.

FIG. 10 depicts an embodiment of a portion of a cameo face of dental prosthesis 22. FIG. 10 depicts a representation of light transmission through a portion of dental prosthesis 22 including support layers 10(A-B).

The method depicted in FIGS. 3-10 for forming dental prosthesis 22 from pliable material 16 including support layers 10(A-B) is merely one embodiment of the method. The embodiment depicted in FIGS. 3-10 is based on a compression molded technique. The embodiment depicted in FIGS. 3-10 should however not be seen as limiting in any fashion. There are many forms of infiltrating resin into a fiber form, or vice versa, known to one skilled in the art. In some embodiments, methods for forming dental prosthesis from pliable material including support layers may include pultrusion, hand lay up, autoclave, resin transfer, bag molding, injection molding, etc. Polymers used in the method may include any polymers known to one skilled in the art, nonlimiting examples of which are described herein. Polymers used may be polymerized in any fashion known to one skilled in the art. Examples of polymerization techniques may include, but are not limited to, light activation (photo-polymerization), chemical cure, thermoplastic cure, thermoset cure, microwave energy cure and/or heat cure.

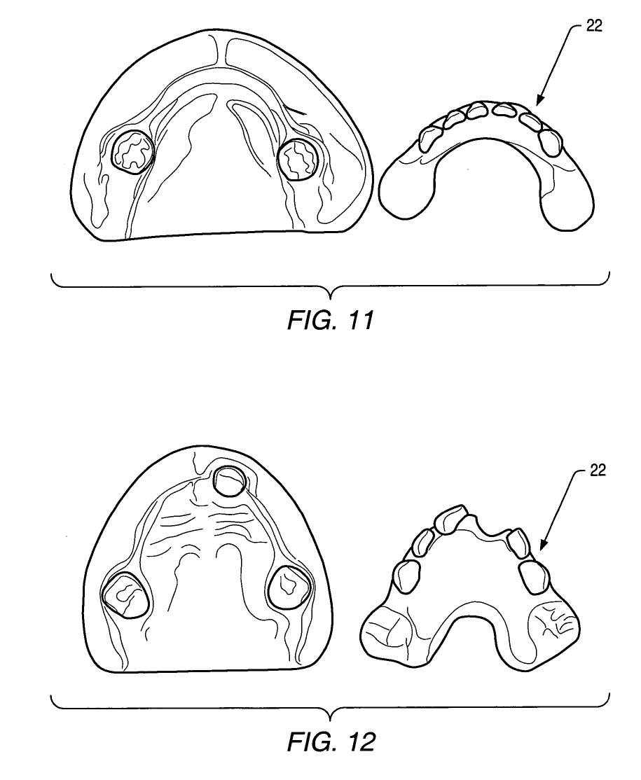

Although an embodiment of the method described herein is directed toward use in the palate of a denture, this should in no way be seen as limiting the scope of the method and system described herein. Methods and systems described herein may be used in other area of prostheses and other types of prostheses. In some embodiments, maxillary and/or mandibular complete dentures may be formed from the methods and/or systems described herein. In some embodiments, partial dentures and/or maxillofacial prostheses may be formed from the methods and/or systems described herein. Any dental and/or medical prostheses may be formed from the methods and/or systems described herein. FIG. 11 depicts an embodiment of a mandibular pediatric complete denture formed using method described herein. FIG. 12 depicts an embodiment maxillary pediatric removable partial denture (entire prostheses has been reinforced and made thin using method described herein.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A portion of a dental prosthesis, comprising:
a pliable material;
at least two support layers, wherein at least two of the support layers comprise a fiber sheet; and
wherein at least two of the support layers are positioned substantially parallel to one another substantially within the pliable material.

2. The portion of claim 1, wherein the portion is less than a predetermined thickness.

3. The portion of claim 1, wherein the portion is less than about 10 mm thick.

4. The portion of claim 1, wherein the portion is less than about 1 mm thick.

5. The portion of claim 1, wherein the portion is less than about 0.5 mm thick.

6. The portion of claim 1, wherein at least two of the support layers are positioned within a predetermined range of at least one of the surfaces of the pliable material

7. The portion of claim 6, wherein the predetermined range is about 100 microns.

8. The portion of claim 6, wherein the predetermined range is about 50 microns.

9. The portion of claim 1, wherein the pliable material is a curable resin.

10. The portion of claim 1, wherein the pliable material comprises polymethyl-methacrylate.

11. The portion of claim 1, wherein the fiber sheet comprises glass fiber.

12. The portion of claim 1, wherein the dental prosthesis comprises a denture.

13. The portion of claim 1, wherein the dental prosthesis comprises a partial denture.

14. A portion of a dental prosthesis, comprising:
a pliable material;
at least two support layers, wherein at least two of the support layers comprise a fiber sheet;
wherein at least two of the support layers are positioned substantially parallel to one another substantially within the pliable material; and
wherein at least two of the support layers are positioned within about 100 microns of at least one of the surfaces of the pliable material.

15. The portion of claim 14, wherein the portion is less than a predetermined thickness.

16. The portion of claim 14, wherein the portion is less than about 10 mm thick.

17. The portion of claim 14, wherein the portion is less than about 1 mm thick.

18. The portion of claim 14, wherein the portion is less than about 0.5 mm thick.

19. The portion of claim 14, wherein at least two of the support layers are positioned within about 50 microns of at least one of the surfaces of the pliable material.

20. The portion of claim 14, wherein the pliable material is a curable resin.

21. The portion of claim 14, wherein the pliable material comprises polymethyl-methacrylate.

22. The portion of claim 14, wherein the fiber sheet comprises glass fiber.

23. The portion of claim 14, wherein the dental prosthesis comprises a denture.

24. The portion of claim 14, wherein the dental prosthesis comprises a partial denture.

25. A portion of a dental prosthesis, comprising:
a pliable material;
at least two support layers, wherein at least two of the support layers comprise a fiber sheet;
wherein at least two of the support layers are positioned substantially parallel to one another substantially within the pliable material;
wherein at least two of the support layers are positioned within about 100 microns of at least one of the surfaces of the pliable material;
wherein the portion is less than about 1 mm thick.

26. The portion of claim 25, wherein the portion is less than about 0.5 mm thick.

27. The portion of claim 25, wherein at least two of the support layers are positioned within about 50 microns of at least one of the surfaces of the pliable material.

28. The portion of claim 25, wherein the pliable material is a curable resin.

29. The portion of claim 25, wherein the pliable material comprises polymethyl-methacrylate.

30. The portion of claim 25, wherein the fiber sheet comprises glass fibre.

31. The portion of claim 25, wherein the dental prosthesis comprises a denture.

32. The portion of claim 25, wherein the dental prosthesis comprises a partial denture.

33. A reinforced portion of a dental prosthesis, comprising:
a pliable material;
at least two support layers, wherein at least two of the support layers comprise a fiber sheet;
wherein at least two of the support layers are positioned substantially parallel to one another substantially within the pliable material; and
wherein at least two of the support layers are positioned within a predetermined range of at least one of the surfaces of the pliable material.

34. The reinforced portion of claim 33, wherein the reinforced portion is less than a predetermined thickness.

35. The reinforced portion of claim 33, wherein the reinforced portion is less than about 1 mm thick.

36. The reinforced portion of claim 33, wherein the reinforced portion is less than about 0.5 mm thick.

37. The reinforced portion of claim 33, wherein the reinforced portion is about 10 mm thick.

38. The reinforced portion of claim 33, wherein the predetermined range is about 100 microns.

39. The reinforced portion of claim 33, wherein the predetermined range is about 50 microns.

40. The reinforced portion of claim 33, wherein the pliable material is a curable resin.

41. The reinforced portion of claim 33, wherein the pliable material comprises polymethyl-methacrylate.

42. The reinforced portion of claim 33, wherein the fiber sheet comprises glass fiber.

43. The reinforced portion of claim 33, wherein the dental prosthesis comprises a denture.

44. The reinforced portion of claim 33, wherein the dental prosthesis comprises a partial denture.

45. A method of forming at least a portion of a dental prosthesis, comprising positioning at least two support layers within a substantially pliable material, wherein at least a first support layer is positioned substantially adjacent a first surface of the pliable material, and wherein at least a second support layer is positioned substantially adjacent a second surface of the pliable material.

46. The method of claim 45, further comprising positioning the first support layer within about 100 microns of the first surface of the pliable material.

47. The method of claim 45, further comprising positioning the second support layer within about 100 microns of the second surface of the pliable material.

48. The method of claim 45, wherein the portion is less than about 1 mm thick.

49. The method of claim 45, wherein the portion is less than about 10 mm thick.

50. The method of claim 45, further comprising positioning at least two of the support layers substantially parallel to each other.

51. The method of claim 45, wherein at least one of the support layers comprises a fiber sheet.

52. The method of claim 45, wherein at least one of the support layers comprises a glass fiber sheet.

53. The method of claim 45, wherein the pliable material is a curable resin.

54. The method of claim 45, wherein the pliable material comprises polymethyl-methacrylate.

55. The method of claim 45, further comprising positioning at least one of the support layers within a predetermined range of at least one of the surfaces of the pliable material.

56. The method of claim 45, further comprising positioning at least one of the support layers within a predetermined range of at least one of the surfaces of the pliable material, wherein the predetermined range is about 100 microns.

57. The method of claim 45, further comprising positioning at least one of the support layers within a predetermined range of at least one of the surfaces of the pliable material, wherein the predetermined range is about 50 microns.

58. The method of claim 45, wherein the dental prosthesis comprises a denture.

59. The method of claim 45, wherein the dental prosthesis comprises a partial denture.
